(19) United States
(12) Patent Application Publication
(10) Pub. No.: US 2007/0174736 A1
(43) Pub. Date: Jul. 26, 2007

(54) Storage medium management apparatus, storage medium management program, and storage medium management method

(75) Inventor: Osamu Yoshida, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/386,357

(22) Filed: Mar. 22, 2006

(30) Foreign Application Priority Data
Dec. 16, 2005 (JP) 2005-362668

(51) Int. Cl. G06F 11/00

(52) U.S. Cl. 714/53

(57) ABSTRACT

There is provided a storage medium management apparatus, a storage medium management program, and a storage medium management method that reduce the write size of defect management information.

A storage medium management apparatus includes: a memory write section that reads out first defect management information which is defective address information written in a storage medium, writes all defective address information which is based on the first defect management information in a memory as total defect information, and, in the case where first subsequent defect information 32 which is information related to a subsequent defect is included in the first defect management information, writes subsequent defect information which is based on the first subsequent defect information 32 in the memory as second subsequent defect information; and a storage medium write section that updates, in the case where a new subsequent defect is detected, the total defect information and second subsequent defect information based on the information of the new subsequent defect and writes subsequent defect information which is based on the second subsequent defect information in the storage medium as first subsequent defect information 32.

### BACKGROUND OF THE INVENTION

1. Field of the Invention

The present invention relates to a storage medium management apparatus, a storage medium management program, and a storage medium management method that manage defects in a storage medium.

2. Description of the Related Art

A storage apparatus such as a disk drive is provided with a mechanism for performing retry operation for a writing error or a reading error. In the case where a disk drive performs retry operation for a writing error but the writing operation ends up in failure, or in the case where the data that has been read out by retry operation performed for a reading error is guaranteed, a changing process is performed.

Numbers (LBA: Logical Block Address) starting from 0 are sequentially assigned to respective sectors in a disk drive by a higher-level device. The changing process is a function of setting an unused sector that is kept in reserve as a changing destination sector and reassigning the LBA that has been assigned to a defective sector to the changing destination sector. Accordingly, after the changing process, the access to the LBA assigned to the defective sector is changed to an access to the changing destination sector and, thereby, the access to the defective sector is avoided.

It is necessary to retain information about changing on a memory as defect management information in order to perform the above changing process. Further, it is necessary to store the defect management information in a system area on a disk medium where information for controlling a disk drive is stored in order to retain the defect management information even after a power supply is cut off. As described above, the disk drive manages correspondence between the LBA and sector, which is called address administration.

A defective sector that is detected at the stage of manufacture of the disk drive is called “initial defect” and defective sector that is subjected to the changing process is called “subsequent defect”. The disk drive performs address management for avoiding an access to these defective sectors in the inside thereof. Therefore, it is only necessary for a higher-level device to give a simple instruction like “perform writing operation of data corresponding to 100 sectors starting from the sector of LBA 100” in access operation.

In the case of the initial defect, a common disk drive skips a sector with the initial defect and assigns an LBA to the subsequent sector (having no defect); whereas in the case of the subsequent defect, a common disk drive performs complicated operation like assigning an LBA to the sector that is kept in reserve at a location not adjacent to the defective sector.

Further, in order to enhance access capability, a common disk drive sorts defective sector addresses in the ascending order to thereby accelerate searching. The defective sector address is a physical address representing the location of the defective sector on a disk medium (corresponding to LBA assigned to a sector having no defect). A heap sort in which variation in the processing time is small and less working memory is required is commonly used as a sort method. By previously sorting the defective sector addresses, it is possible to reduce the time required to calculate the physical positions of a cylinder, head, and sector from the LBA to minimum. Thus, the disk drive detects a subsequent defect, updates defect management information on a memory for each changing process and sorts the information, and writes the information in a system area on the disk medium once again. The defect management information on the disk medium thus created is referred to as first defect management information, and defect management information on the memory is referred to as second defect management information.

The format of the defect management information will next be described.

Firstly, the second defect management information which is the defect management information on the memory will be described. FIG. 6 is a table showing an example of conventional second defect management information. The conventional second defect management information consists of second total defect information 133 and second subsequent defect information 134. In the second total defect information 33, defective sector addresses of all defective sectors and defect types indicating whether a given defective sector is initial defect (represented as “INITIAL” in the table) or subsequent defect (represented as “CHANGING” in the table) are recorded. After new information related to the subsequent defect has been added thereto, the second total defect information 133 is sorted in the ascending order of the defective sector addresses when a changing process is performed. In the second subsequent defect information 134, defective sector addresses of the subsequent defects and positions of changing destination sectors, which are positions on the disk medium assigned by a changing process as substitutes for the subsequent defective sectors, are recorded. After new information related to the subsequent defect has been added thereto, the second subsequent defect information 134 is sorted in the ascending order of the defective sector addresses when a changing process is performed.

Next, the first defect management information which is the defect management information on the disk medium will be described. FIG. 7 is a table showing an example of conventional first defect management information. The conventional first defect management information consists of first total defect information 131 and first subsequent defect information 132. The sorted second defect management information is recorded in the system area of the storage medium without change. Therefore, the second total defect information 133 and first total defect information 131 are equal to each other, and the second subsequent defect information 134 and first subsequent defect information 132 are equal to each other.

As a prior art related to the present invention, Jpn. Pat. Appln. Laid-Open Publication No. 2000-57698 is known. A disk storage drive disclosed in the above publication performs skip processing as a substitution process of the subsequent defect occurring at operating time and, after that, performs slip processing after power has been restored to allow a high-speed and safe substitution process to thereby reconstruct the continuity between sectors lost during the operating time.

In recent years, however, the number of pieces of defect management information is increased with an increase in the capacity of a disk drive. When the size of the defect management information exceeds 100 sectors, there is a risk that a writing error occurs in the update of the defect management information.

Further, in recent years, a disk drive has come to be used for home appliance such as a DVD recorder or even in an automobile and is supposedly be used not only under a controlled environment but also under an environment where there is vibration. Under such an environment where vibration is applied to the disk drive, there is a possibility that writing operation of defect management information of a large data size cannot be performed correctly. If, in this state, power is off and then is turned on, user data may be lost in some cases due to incorrect update of the defect management information.

### SUMMARY OF THE INVENTION

The present invention has been made to solve the above problems, and an object thereof is to provide a storage medium management apparatus, storage medium management program, and a storage medium management method that reduce the write size of the defect management information.

To solve the above problems, according to a first aspect of the present invention, there is provided a storage medium management apparatus that manages information of a defective address in order to avoid an access to the defective address on a storage medium, comprising: a memory write section that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and a storage medium write section that updates, in the case where a new subsequent defect is detected, the total defect information and second subsequent defect information based on the information of the new subsequent defect and writes subsequent defect information which is based on the second subsequent defect information in the storage medium as first subsequent defect information.

In the storage medium management apparatus according to the present invention, the first defect management information includes initial defect information which is information related to a previously detected initial defect, the initial defect information includes position information of an initial defect, each of the first and second subsequent defect information includes position information of a subsequent defect and position information of a changing destination corresponding the subsequent defect, and the total defect information includes position information of each defective address and defect types indicating whether the defective address is initial defect or subsequent defect.

In the storage medium management apparatus according to the present invention, the memory write section adds the defect types to the position information in the initial defect information and that in the first subsequent defect information, merges both the information, and generates the total defect information by sorting the merged information based on the position information.

In the storage medium management apparatus according to the present invention, the storage medium write section adds the information related to a new subsequent defect to the total defect information and sorts the total defect information based on the position information of defective addresses to update the total defect information, as well as adds the information related to a new subsequent defect to the second subsequent defect information and sorts the second subsequent defect information based on the position information of subsequent defect to update the second subsequent defect information.

In the storage medium management apparatus according to the present invention, the memory write section writes the first subsequent defect information in a memory as the second subsequent defect information without change, and the storage medium write section writes the second subsequent defect information in a storage medium as the first subsequent defect information without change.

In the storage medium management apparatus according to the present invention, in the case where a correct writing of the first subsequent defect information cannot be performed, the storage medium write section activates a timer and retries the writing of the first subsequent defect information at predetermined timing after the previous writing operation.

In the storage medium management apparatus according to the present invention, in the case where a correct writing of the first subsequent defect information cannot be performed, the storage medium write section retries the writing of the first subsequent defect information at predetermined timing of receiving, from a higher-level device, a command that instructs writing of write cache data in the storage medium.

According to a second aspect of the present invention, there is provided a storage medium management program allowing a computer to execute management of information of a defective address in order to avoid an access to the defective address on a storage medium, the program allowing the computer to execute: a memory write step that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and a storage medium write step that updates, in the case where a new subsequent defect is detected, the total defect information and second subsequent defect information based on the information of the new subsequent defect and writes subsequent defect information which is based on the second subsequent defect information in the storage medium as first subsequent defect information.

In the storage medium management program according to the present invention, the first defect management information includes initial defect information which is information related to a previously detected initial defect, the initial defect information includes position information of an initial defect, each of the first and second subsequent defect information includes position information of a subsequent defect and position information of a changing destination corresponding the subsequent defect, and the total defect information includes position information of each defective address and defect types indicating whether the defective address is initial defect or subsequent defect.

In the storage medium management program according to the present invention, the memory write step adds the defect types to the position information in the initial defect information and that in the first subsequent defect information, merges both the information, and generates the total defect information by sorting the merged information based on the position information.

In the storage medium management program according to the present invention, the storage medium write step adds the information related to a new subsequent defect to the total defect information and sorts the total defect information based on the information of defective addresses to update the total defect information, as well as adds the information related to a new subsequent defect to the second subsequent defect information and sorts the second subsequent defect information based on the position information of subsequent defect to update the second subsequent defect information.

In the storage medium management program according to the present invention, the memory write step writes the first subsequent defect information in a memory as the second subsequent defect information without change, and the storage medium write step writes the second subsequent defect information in a storage medium as the first subsequent defect information without change.

In the storage medium management program according to the present invention, in the case where a correct writing of the first subsequent defect information cannot be performed, the storage medium write step activates a timer and retries the writing of the first subsequent defect information at predetermined timing after the previous writing operation.

In the storage medium management program according to the present invention, in the case where a correct writing of the first subsequent defect information cannot be performed, the storage medium write step retries the writing of the first subsequent defect information at predetermined timing of receiving, from a higher-level device, a command that instructs writing of write cache data in the storage medium.

According to a third aspect of the present invention, there is provided a storage medium management method that manages information of a defective address in order to avoid an access to the defective address on a storage medium, comprising: a memory write step that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and a storage medium write step that updates, in the case where a new subsequent defect is detected, the total defect information and second subsequent defect information based on the information of the new subsequent defect and writes subsequent defect information which is based on the second subsequent defect information in the storage medium as first subsequent defect information.

According to the present invention, the size of the data to be written in the system area of the storage medium at the time of the changing process is reduced to reduce the number of writing errors, thereby increasing reliability of the storage apparatus.

### BRIEF DESCRIPTION OF THE DRAWINGS

FIG. 1 is a block diagram showing a configuration example of a disk drive according to an embodiment of the present invention;

FIG. 2 is a table showing an example of first defect management information according to the embodiment;

FIG. 3 is a table showing an example of second defect management information according to the embodiment;

FIG. 4 is a flowchart showing an example of second defect management information generation operation according to the embodiment;

FIG. 5 is a flowchart showing an example of operation of a changing process according to the embodiment;

FIG. 6 is a table showing an example of conventional second defect management information; and

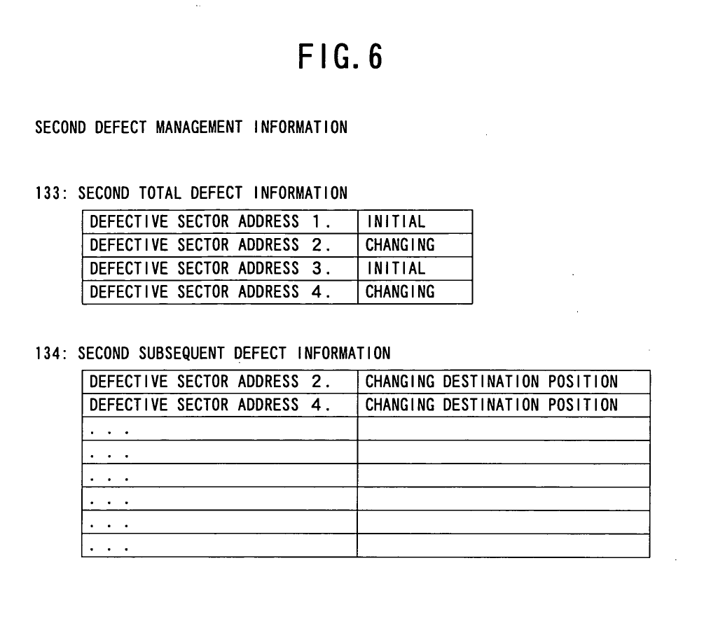

FIG. 7 is a table showing an example of conventional first defect management information.

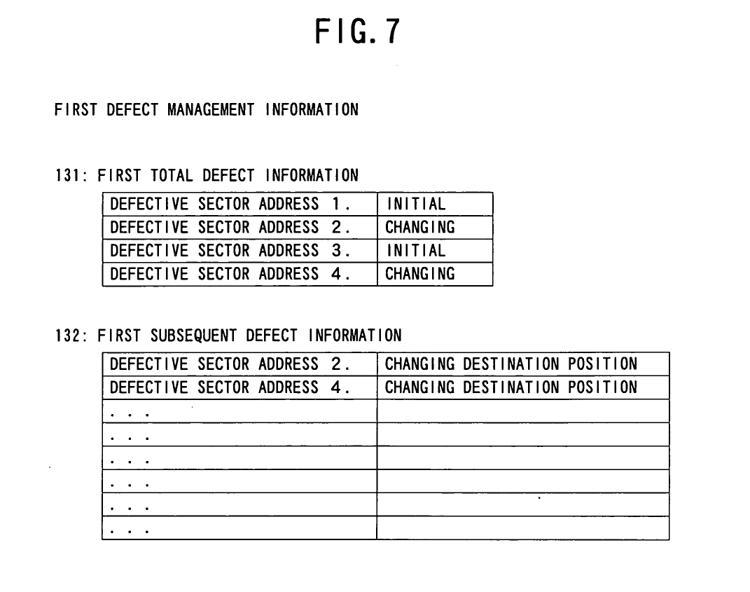

### DETAILED DESCRIPTION OF THE PREFERRED EMBODIMENTS

An embodiment of the present invention will be described below with reference to the accompanying drawings.

Firstly, a configuration of a storage apparatus (disk drive) according to the embodiment of the present invention will be described.

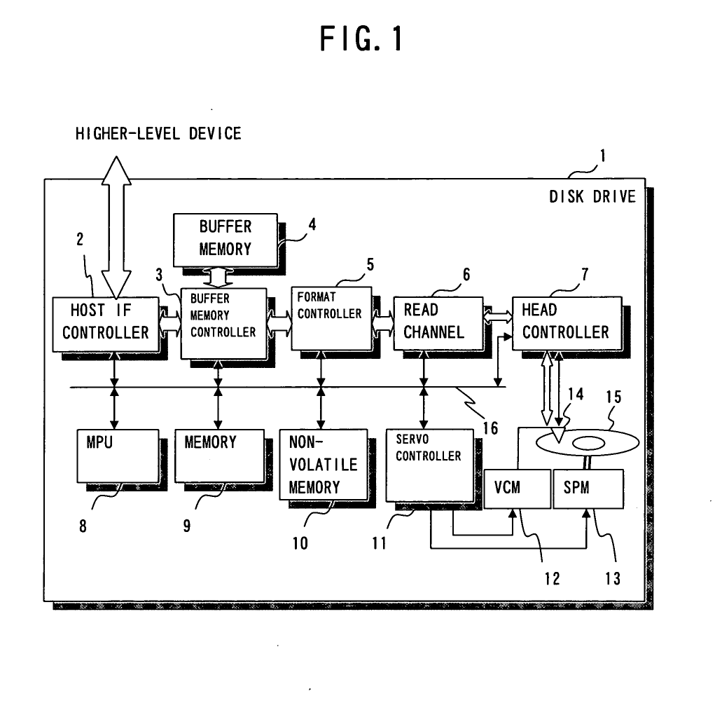

FIG. 1 is a block diagram showing a configuration example of the disk drive according to the embodiment of the present invention. A disk drive 1 (hard disk drive) includes a host IF (interface) controller 2, a buffer memory controller 3, a buffer memory 4, a format controller 5, a read channel 6, a head controller 7, an MPU (Micro Processing Unit) 8, a memory 9, a non-volatile memory (Flash ROM) 10, a servo controller 11, a voice coil motor (VCM) 12, a spindle motor 13, a head 14, a disk medium 15, and a common bus 16. The disk drive 1 is connected to a higher-level device through the host IF controller 2.

The MPU 8 controls the above components of the disk drive 1 and has a timer function. The memory 9 is a volatile memory and stores control data that the MPU 8 uses or a control program, as well as defect management information. The non-volatile memory 10 stores a control program that the MPU 8 uses. The servo controller 11 controls operations of the VCM 12 and SPM 13. The VCM 12 drives the head 14. The SPM 13 rotates the disk medium 15. When a higher-level device accesses the disk medium 15, data flows among the higher-level device, host IF controller 2, buffer memory controller 3, buffer memory 4, format controller 5, read channel 6, head controller 7, and head 14, as represented by thick arrows in the drawing.

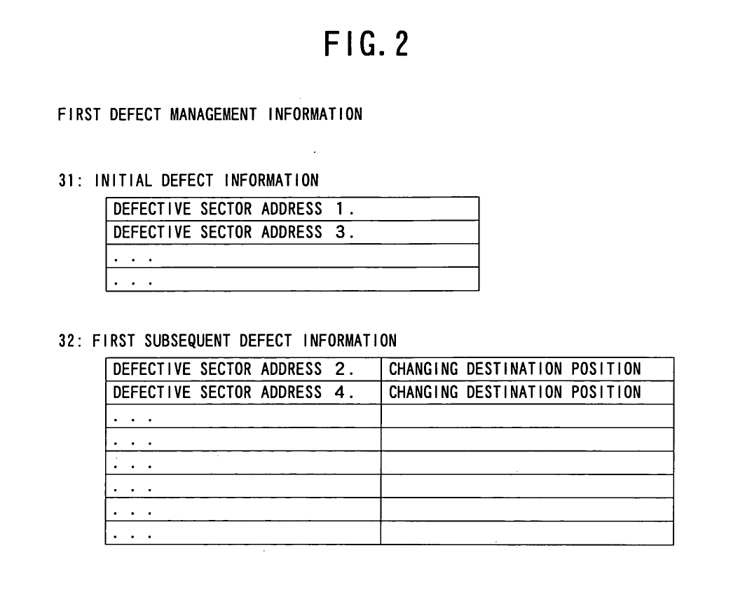

Next, the first defect management information according to the embodiment, which is defect management information on the disk medium 15, will be described. FIG. 2 is a table showing an example of the first defect management information according to the embodiment. The first defect management information consists of initial defect information 31 and first subsequent defect information 32. Unlike the conventional first total defect information 131, the initial defect information 31 includes only the defective sector addresses corresponding to the initial defects. The first subsequent defect information 32 and conventional first subsequent defect information 132 are equal to each other.

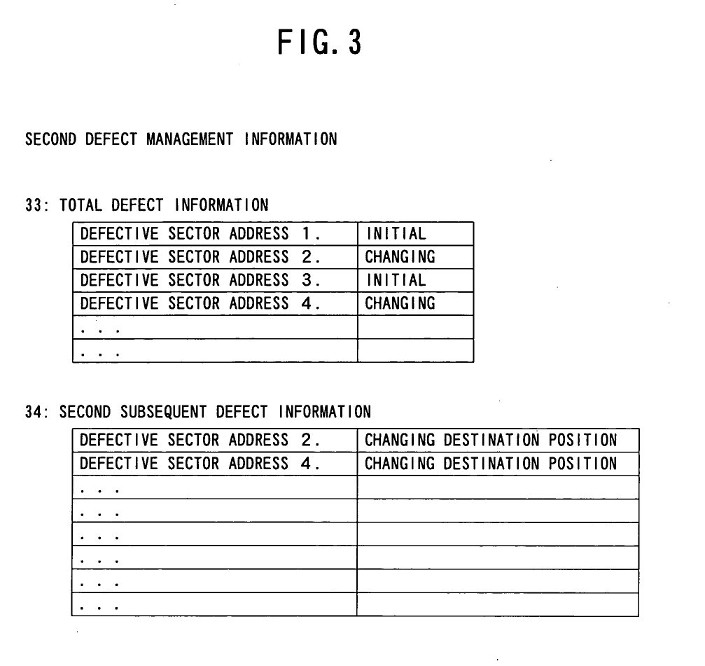

Next, the second defect management information according to the embodiment, which is defect management information on the memory 9, will be described. FIG. 3 is a table showing an example of the second defect management information according to the embodiment. The second defect management information consists of total defect information 33 and second subsequent defect information 34. Second defect management information generation operation (to be describes later) makes the total defect information 33 equal to the conventional second total defect information 133 and makes the second subsequent defect information 34 equal to the conventional second subsequent defect information 134.

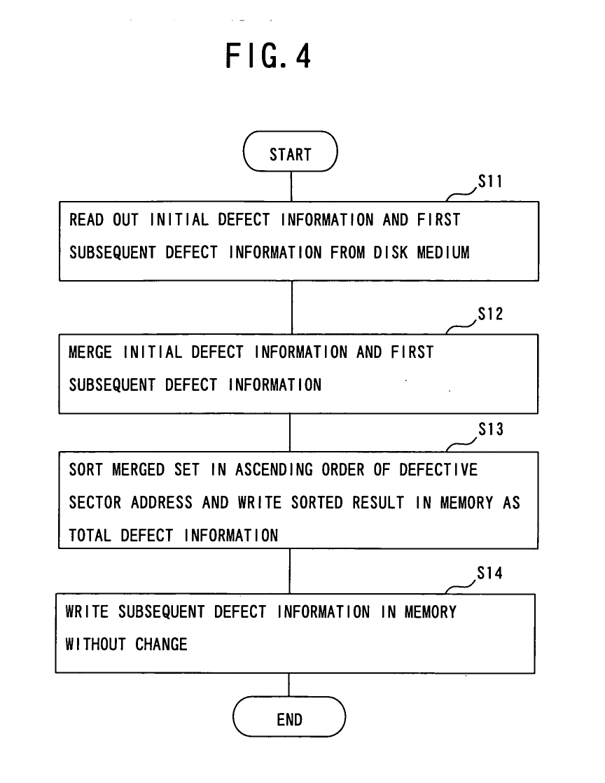

At the start-up process, where power is turned on to allow a disk to be in steady rotation at a predetermined rotation speed and initialization to be completed and the disk enters a data read/write ready state, the MPU 8 reads out the first defect management information and generates the second defect management information. FIG. 4 is a flowchart showing an example of second defect management information generation operation according to the embodiment. At the star-up time of the disk drive 1, the MPU 8 reads out the first defect management information from the system area of the disk medium 15 (S11). Then the MPU 8 adds the defect type information to the defective sector addresses of the initial defect information 31 and first subsequent defect information 32 included in the read out first defect management information, merges them into one set (S12), sort the set in the ascending order of the defective sector addresses, and writes the sorted result in the memory 9 as the total defect information 33 of the second defect management information (S13). The MPU 8 then writes the content of the first subsequent defect information 32 in the memory 9 without change as the second subsequent defect information 34 of the second defect management information (S14) and ends this flow.

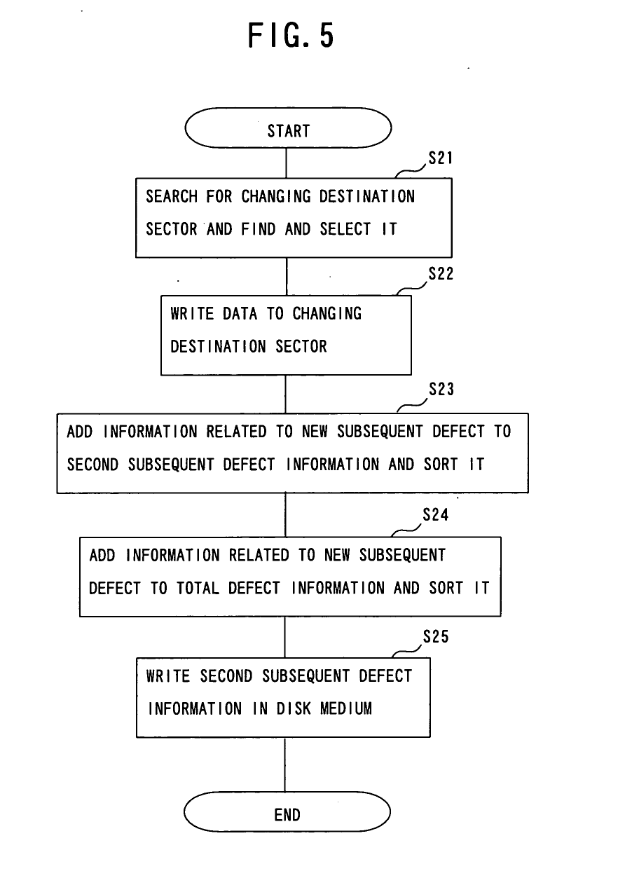

When a new subsequent defect is detected, the MPU 8 performs a changing process and updates the second defect management information and first defect management information. FIG. 5 is a flowchart showing an example of operation of the changing process according to the embodiment. When a new subsequent defect is detected, the MPU 8 searches for a changing destination sector, finds and selects it (S21), and writes data to the changing destination sector (S22). Then the MPU 8 adds information related to the new subsequent defect to the total defect information 33 of the second defect management information and sorts the total defect information 33 in the ascending order of the defective sector addresses (S23). Similarly, the MPU 8 adds information related to the new subsequent defect to the second subsequent defect information 34 of the second defect management information and sorts the second subsequent defect information 34 in the ascending order of the defective sector addresses (S24). The MPU 8 then writes the content of the second subsequent defect information 34 of the second defect management information to the first subsequent defect information 32 of the first defect management information for update (S25) and ends this flow. Therefore, in the system area of the disk medium 15, the initial defect information 31 remains unchanged; whereas the first subsequent defect information 32 is updated for each changing process. Further, as described above, the total defect information 33 of the second defect management information is restored from the initial defect information 31 and first subsequent defect information 32 at the start-up time.

While the conventional disk drive writes the first total defect information 131 and first subsequent defect information 132 that constitute the entire first defect management information in the disk medium at the time of the changing process, the disk drive according to the embodiment of the present invention writes only the second subsequent defect information 34 in the disk medium at the time of the changing process. That is, the disk drive according to the embodiment is configured to generate the total defect information from the initial defect information and first subsequent defect information of the first defect management information at the start-up time of the disk drive, thereby eliminating the need to write the total defect information in the disk medium. Therefore, the size of the data to be written in the disk medium at the time of the changing process is reduced to reduce the number of writing errors of the defect management information, thereby increasing reliability of the disk drive.

In the case where a given external condition such as vibration prevents a correct writing of the first defect management information, the MPU 8 activates a timer and retries the writing of the first defect management information at predetermined timing after the previous writing operation. Alternatively, the MPU 8 retries the writing of the first defect management information at the timing of receiving, from a higher-level device, a command (Flash cache command, in the case of a disk drive having SATA I/F) that instructs writing of write cache data in the disk medium.

The storage medium management apparatus according to the embodiment can easily be applied to a storage apparatus and can enhance the capability thereof. Examples of a storage medium used in the storage apparatus include a magnet disk, an optical disk, and magnet-optical disk.

Further, it is possible to provide a program that allows a computer constituting the storage medium management apparatus to execute the above steps as a storage medium management program. By storing the above program in a computer-readable storage medium, it is possible to allow the computer constituting the storage medium management apparatus to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

The processing at the start-up time performed by the MPU in the above embodiment corresponds to a memory write section and memory write step. The processing at the changing process performed by the MPU in the above embodiment corresponds to a storage medium write section and storage medium write step.

What is claimed is:

1. A storage medium management apparatus that manages information of a defective address in order to avoid an access to the defective address on a storage medium, comprising:
a memory write section that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and
a storage medium write section that updates, in the case where a new subsequent defect is detected, the total defect information and second subsequent defect information based on the information of the new subsequent defect and writes subsequent defect information which is based on the second subsequent defect information in the storage medium as first subsequent defect information.

2. The storage medium management apparatus according to claim 1, wherein
the first defect management information includes initial defect information which is information related to a previously detected initial defect,
the initial defect information includes position information of an initial defect,
each of the first and second subsequent defect information includes position information of a subsequent defect and position information of a changing destination corresponding the subsequent defect, and
the total defect information includes position information of each defective address and defect types indicating whether the defective address is initial defect or subsequent defect.

3. The storage medium management apparatus according to claim 2, wherein
the memory write section adds the defect types to the position information in the initial defect information and that in the first subsequent defect information, merges both the information, and generates the total defect information by sorting the merged information based on the position information.

4. The storage medium management apparatus according to claim 2, wherein
the storage medium write section adds the information related to a new subsequent defect to the total defect information and sorts the total defect information based on the position information of defective addresses to update the total defect information, as well as adds the information related to a new subsequent defect to the second subsequent defect information and sorts the second subsequent defect information based on the position information of subsequent defect to update the second subsequent defect information.

5. The storage medium management apparatus according to claim 1, wherein
the memory write section writes the first subsequent defect information in a memory as the second subsequent defect information without change, and
the storage medium write section writes the second subsequent defect information in a storage medium as the first subsequent defect information without change.

6. The storage medium management apparatus according to claim 1, wherein
in the case where a correct writing of the first subsequent defect information cannot be performed, the storage medium write section activates a timer and retries the writing of the first subsequent defect information at predetermined timing after the previous writing operation.

7. The storage medium management apparatus according to claim 1, wherein
in the case where a correct writing of the first subsequent defect information cannot be performed, the storage medium write section retries the writing of the first subsequent defect information at predetermined timing of receiving, from a higher-level device, a command that instructs writing of write cache data in the storage medium.

8. A storage medium management program allowing a computer to execute management of information of a defective address in order to avoid an access to the defective address on a storage medium, the program allowing the computer to execute:
a memory write step that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and
a storage medium write step that updates, in the case where a new subsequent defect is detected, the total defect information and second subsequent defect information based on the information of the new subsequent defect and writes subsequent defect information which is based on the second subsequent defect information in the storage medium as first subsequent defect information.

9. The storage medium management program according to claim 8, wherein
the first defect management information includes initial defect information which is information related to a previously detected initial defect,
the initial defect information includes position information of an initial defect,
each of the first and second subsequent defect information includes position information of a subsequent defect and position information of a changing destination corresponding the subsequent defect, and
the total defect information includes position information of each defective address and defect types indicating whether the defective address is initial defect or subsequent defect.

10. The storage medium management program according to claim 9, wherein
the memory write step adds the defect types to the position information in the initial defect information and that in the first subsequent defect information, merges both the information, and generates the total defect information by sorting the merged information based on the position information.

11. The storage medium management program according to claim 9, wherein
the storage medium write step adds the information related to a new subsequent defect to the total defect information and sorts the total defect information based on the position information of defective addresses to update the total defect information, as well as adds the information related to a new subsequent defect to the second subsequent defect information and sorts the second subsequent defect information based on the position information of subsequent defect to update the second subsequent defect information.

12. The storage medium management program according to claim 8, wherein
the memory write step writes the first subsequent defect information in a memory as the second subsequent defect information without change, and
the storage medium write step writes the second subsequent defect information in a storage medium as the first subsequent defect information without change.

13. The storage medium management program according to claim 8, wherein
in the case where a correct writing of the first subsequent defect information cannot be performed, the storage medium write step activates a timer and retries the writing of the first subsequent defect information at predetermined timing after the previous writing operation.

14. The storage medium management program according to claim 8, wherein
in the case where a correct writing of the first subsequent defect information cannot be performed, the storage medium write step retries the writing of the first subsequent defect information at predetermined timing of receiving, from a higher-level device, a command that instructs writing of write cache data in the storage medium.

15. A storage medium management method that manages information of a defective address in order to avoid an access to the defective address on a storage medium, comprising:
a memory write step that reads out first defect management information which is defective address information written in the storage medium, writes all defective address information which is based on the first defect management information in a memory as total defect information, and, in the case where first subsequent defect information which is information related to a subsequent defect is included in the first defect management information, writes subsequent defect information which is based on the first subsequent defect information in the memory as second subsequent defect information; and
a storage medium write step that updates, in the case where a new subsequent defect is detected, the total defect information and second subsequent defect information based on the information of the new subsequent defect and writes subsequent defect information which is based on the second subsequent defect information in the storage medium as first subsequent defect information.

16. The storage medium management method according to claim 15, wherein
the first defect management information includes initial defect information which is information related to a previously detected initial defect,
the initial defect information includes position information of an initial defect,
each of the first and second subsequent defect information includes position information of a subsequent defect and position information of a changing destination corresponding the subsequent defect, and
the total defect information includes position information of each defective address and defect types indicating whether the defective address is initial defect or subsequent defect.

17. The storage medium management method according to claim 16, wherein
the memory write step adds the defect types to the position information in the initial defect information and that in the first subsequent defect information, merges both the information, and generates the total defect information by sorting the merged information based on the position information.

18. The storage medium management method according to claim 16, wherein
the storage medium write step adds the information related to a new subsequent defect to the total defect information and sorts the total defect information based on the position information of defective addresses to update the total defect information, as well as adds the information related to a new subsequent defect to the second subsequent defect information and sorts the second subsequent defect information based on the position information of subsequent defect to update the second subsequent defect information.

19. The storage medium management method according to claim 15, wherein
the memory write step writes the first subsequent defect information in a memory as the second subsequent defect information without change, and
the storage medium write step writes the second subsequent defect information in a storage medium as the first subsequent defect information without change.

20. The storage medium management method according to claim 15, wherein
in the case where a correct writing of the first subsequent defect information cannot be performed, the storage medium write step activates a timer and retries the writing of the first subsequent defect information at predetermined timing after the previous writing operation.
